(19) United States
(12) Patent Application Publication
(10) Pub. No.: US 2009/0164438 A1
(43) Pub. Date: Jun. 25, 2009

(54) MANAGING AND CONDUCTING ON-LINE SCHOLARLY JOURNAL CLUBS

(75) Inventor: John Delacruz, Pasadena, CA (US)

Correspondence Address: LYON & HARR, LLP, 300 ESPLANADE DRIVE, SUITE 800, OXNARD, CA, 93036, US

(73) Assignee: California Institute of Technology, Pasadena, CA (US)

(21) Appl. No.: 12/339,789

(22) Filed: Dec. 19, 2008

Related U.S. Application Data
(60) Provisional application No. 61/008,206, filed on Dec. 19, 2007.

(51) Int. Cl. G06F 7/06; G06F 17/30

(52) U.S. Cl. 707/3; 707/100; 707/E17.044; 707/E17.108; 707/E17.014

(57) ABSTRACT

Presented are embodiments for the creation and management of online scholarly journal clubs, as well as for facilitating the proceedings of the clubs. In one general embodiment, a journal club server receives bibliographic entries from a user. These received bibliographic entries are stored in a database. An identifier is assigned to each new bibliographic entry stored. In one implementation, the same identifier is assigned to each bibliographic entry corresponding to the same scholarly work. Association requests are also received from users and implemented to associate at least one of, another user, or a group of users (e.g., a journal club), or a content item, with a stored bibliographic entry. This association is accomplished using the bibliographic entry's identifier. Once a bibliographic entry is stored in the server database, a user, or a group of users, can access the entry and content items associated with it.

### BACKGROUND

A journal club is a group of individuals, typically associated with a university or hospital, who meets regularly to discuss and evaluate scholarly research articles within a particular area of interest. Journal clubs facilitate meaningful scholarly discussion, enable the participants to stay current in their field by highlighting important articles, and provide a learning experience for students. Often times while discussing and evaluating an article, participants uncover potential flaws, identify related research, and produce new and valuable insight.

### SUMMARY

Embodiments described herein generally provide for the creation and management of online scholarly journal clubs, as well as for facilitating the proceedings of the clubs. For example, in one general embodiment, a journal club server receives bibliographic entries from a user via the user's client computer over a client-server based computer network (such as a private intranet or the Internet). In general, a bibliographic entry provides bibliographic information about a scholarly work and represents the work. These received bibliographic entries are stored in a database that is accessible by the journal club server. An identifier is assigned to each new bibliographic entry stored. In one implementation, the same identifier is assigned to each bibliographic entry corresponding to the same scholarly work. Association requests are also received from users and implemented to associate at least one of, another user, or a group of users (e.g., a journal club), or a content item, with a stored bibliographic entry. This association is accomplished using the bibliographic entry's identifier. Non-limiting examples of the types of content items that can be associated with a bibliographic entry include text, images, video, binary files, keywords, hyperlinks, ratings, and other bibliographic entries. Once a bibliographic entry is stored in the server database, a user, or a group of users, can access the entry and content items associated with it.

It should be noted that this Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

The specific features, aspects, and advantages of the disclosure will become better understood with regard to the following description, appended claims, and accompanying drawings where:

FIG. 1 is a simplified diagram of a suitable client-server based computer network environment in which embodiments that are described herein for managing and conducting on-line scholarly journal clubs can operate.

FIG. 2 is a flow diagram generally outlining one embodiment of a process for managing and conducting on-line scholarly journal clubs.

FIG. 3 is a simplified diagram showing exemplary primary and secondary associations between users and content items.

FIG. 4 is a flow diagram generally outlining an exemplary implementation of how a bibliographic entry can be provided based on the input of bibliographic information.

FIG. 5 is a flow diagram generally outlining an exemplary implementation of how a bibliographic entry can be provided based on the input of a recognized bibliographic database identifier.

FIG. 6 is a flow diagram generally outlining an exemplary implementation of how a bibliographic entry can be provided based on the input of a URL.

FIG. 7 is a flow diagram generally outlining an exemplary implementation of how a bibliographic entry can be provided based on the input of a file that includes a list of bibliographic entries.

FIG. 8 is a flow diagram generally outlining an exemplary implementation of how a bibliographic entry can be provided based on the input of a document file.

FIG. 9 is a flow diagram generally outlining an exemplary implementation of an aggregated feed feature of the online journal club.

FIG. 10 is a diagram depicting a general purpose computing device constituting an exemplary system for implementing embodiments for managing and conducting on-line scholarly journal clubs that are described herein.

### DETAILED DESCRIPTION

In the following description of embodiments for managing and conducting on-line scholarly journal clubs, reference is made to the accompanying drawings which form a part hereof, and which are shown for the purposes of illustrating the described embodiments. It is understood that other embodiments may be utilized and structural changes may be made without departing from the scope of the invention.

### 1.0 Managing And Conducting On-Line Scholarly Journal Clubs

The various embodiments for managing and conducting on-line scholarly journal clubs described herein generally provide a user interface and enable users to, among other things: create online journal clubs; browse, search for, and join existing online journal clubs; manage and conduct online journal clubs; create content items, bibliographic entries, metadata, and user profiles; create and view associations between online journal clubs, content items, bibliographic entries, metadata, files, and users; subscribe to feeds from online journal clubs, content items, bibliographic entries, metadata, files, and users; search for, browse, view, sort, and organize content items, bibliographic entries, metadata, files, users, and associations; and receive recommendations of online journal clubs, content items, bibliographic entries, metadata, files, and user profiles.

These features provide many advantages. For example, journal club participants can easily archive, organize, and share the discussion that takes place within a journal club. In addition, participants can easily organize and discuss research articles or topics both prior to and after meeting in person. In such a system, summaries and background information can be shared beforehand, and follow up discussion can continue long after the meeting takes place, as new ideas arise. Further, the global community of scientists, physicians, and scholars can form journal clubs and hold discussion regardless of their physical location. Still further, journal club participants can easily find journal clubs, articles, and discussions relevant to their field of interest. Journal club participants can also associate discussions and other content, such as text, images, video, binary files, keywords, hyperlinks, ratings, with research articles.

### 1.1 Online Journal Club Network Environment

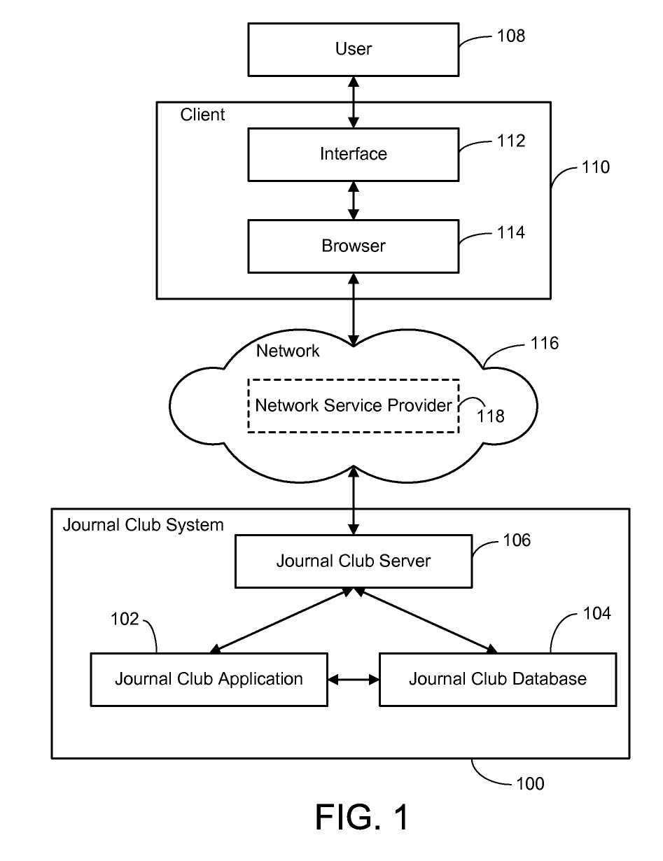

Before describing the various embodiments for managing and conducting on-line scholarly journal clubs, a general description of a suitable client-server based computer network environment in which portions thereof may be implemented will be described. As shown in FIG. 1, the online journal club network environment includes an online journal club system 100 having a journal club application 102, at least one database 104, and at least one computing device (such as any of the computing devices described in the computing environment section and generally referred to herein as a computer). The computer acts as a journal club server 106 for the network. The journal club application 102 has access to the database 104. Both the journal club application 102 and database 104 are in communication with the journal club server 106. The journal club application 102 can be written in any appropriate computer programming language (e.g., PHP). The journal club application 102 uses the database 104 (e.g., MySQL) to store and retrieve data. The journal club server 106 executes machine readable instructions associated with the journal club application 102. A user 108, via a client computer 110 (such as any of the computing devices described in the computing environment section), interacts with the online journal club server 106 using an interface 112 that operates on a web browser 114, both of which run on the client computer. The client computer 110 is in communication with the journal club server 106 via a computer network 116, such as the Internet or a private intranet. This communication link can be through at least one intermediary network service provider 118 (which is shown in FIG. 1 as a broken line box to indicate its optional nature). In one embodiment, the interface 112 includes a navigation bar that provides hyperlinks that can be utilized by the user to access various features of the online journal club. Features can also be accessed without of the navigation bar.

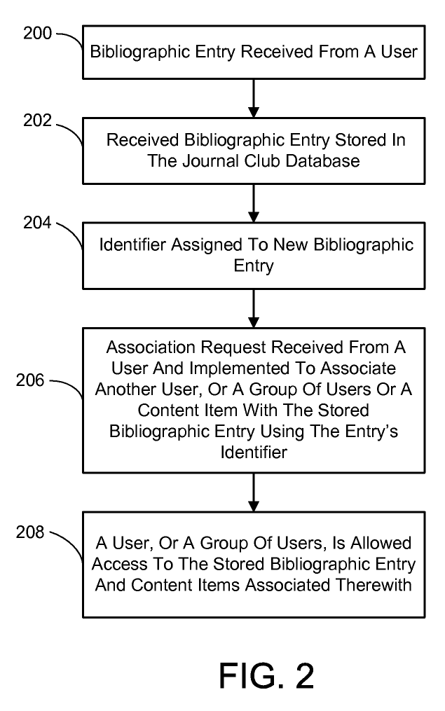

Given the foregoing environment, one general embodiment of a process for managing and conducting an online scholarly journal club can be accomplished as illustrated in FIG. 2. From the journal club server perspective, bibliographic entries are received from users (200), and stored in the database (202). A bibliographic entry is generally defined as a representation of a scholarly work. An identifier is assigned to each new bibliographic entry stored (204). It is noted that in one implementation, the same identifier is assigned to each bibliographic entry corresponding to the same scholarly work. An association request is also received from a user and implemented to associate at least one of, another user, or a group of users (e.g., a journal club), or a content item, with a stored bibliographic entry using the entry's identifier (204). A user, or a group of users, is then allowed access to a stored bibliographic entry and any content item associated therewith (206). These and many additional features for managing and conducting online scholarly journal clubs will be discussed in greater detail in the sections to follow.

### 1.2 Users

In order to use certain features of the online journal club, in one embodiment a user creates an account and logs into the system. For instance, if the user does not log into the system, the user may still be able to view content items, but not create them. Content items will be described in a following section. When creating the account, in one implementation the user inputs certain identifying data. Non-limiting examples of this data include the user's real name, a username, email address, university, areas of interest, and position. Some of the data may be required, other data can be optional. In one version, the user can choose which data is made publicly available.

To verify the user's email address, in one embodiment the online journal club system sends a confirmation to the address. The creation of new accounts can be limited to users with certain IP addresses or email address domains, which may be used to restrict access to certain institutions. In one implementation, the online journal club system assigns each user a unique user ID in order to store information associated with the user in the database.

In one implementation, the online journal club system provides the user with an online contact form in order to contact other users. Non-limiting examples of ways in which users can be contacted may include email, RSS feeds, SMS messages, and notifications displayed by the aforementioned client computer interface.

### 1.3 Online Journal Clubs

In general, the online journal club scheme allows a user to create a journal club. When creating a journal club, in one embodiment the aforementioned interface prompts the user to enter information and options regarding the journal club. Non-limiting examples of information regarding the journal club includes the name of the journal club, a description, key words, subject area, affiliation, and geographic location. Information associated with the journal club is stored in the aforementioned database. In one implementation, the user who creates the journal club is known as the moderator of the journal club. The moderator has the ability to change the information regarding the journal club. The moderator also has the ability to set certain options for the journal club. Non-limiting examples of these options include rules for who may join, rules for who may associate content with the journal club, rules for who may view content associated with the journal club, and what information is made publicly available.

Once the journal club is created by the user, in one implementation where for instance communication between the user's client computer and the journal club server is via the Internet, a unique Universal Resource Locator (URL) is assigned to the journal club such that other users may access it via the URL. Accessing the journal club enables users to easily view information regarding the journal club and content associated with the journal club. Depending on the options set by the moderator when creating or modifying the journal club, in one implementation users may choose to become members of the journal club. A list of the members belonging to the journal club can be viewed by other users. In one version, the moderator can choose to manually approve users before they can become members of the journal club. In one further implementation, the moderator can edit content associated with the journal club and assign other users to be journal club moderators.

In one embodiment, users can browse existing journal clubs using a journal club directory provided by the server. This directory lists the journal clubs currently stored in the system database. In one implementation, the moderator of a journal club may have the option to prevent the journal club from being listed in the journal club directory. The directory can also provide information about each journal club. Non-limiting examples of information about a journal club includes the name of the journal club, a brief description, and number of members. In one version, users are able to sort the list based on certain criteria, or search the list using key words.

The moderator, and optionally members of the journal club, are provided with a set of tools that enable them to manage and conduct the journal club. Non-limiting examples of these tools include the ability to associated content items, metadata, and files with the journal club; invite users to join the journal club; contact members of the journal club; set options for the journal club; and schedule and view events. In one implementation, members of the journal club have the ability to create private content, which only other members (all or a specified group) of the journal club are able to view. Both members and non-members of a journal clubs can be provided with an online contact form in order to contact the moderator of the journal club.

### 1.4 Content Items

A content item is a type of data that the user inputs into the online journal club system, or may be automatically generated by the system. The content item includes at least one data field, which may be stored in the database. A content type is a subtype of the content items. Different content types may be processed differently by the system. Non-limiting examples of content types include articles, posts, blog posts, reviews, recommendations, wikis, events, comments, and bibliographic entries. When the user creates new content items, in one embodiment the user is presented with a set of data fields in order to input content data. These data fields can be tailored for each content type. For instance, if the user is creating a content type associated with an event, the input fields can include the date and time of the event. Non-limiting examples of content data fields may include author, date, title, body, date created, date of event, and location of event. In one implementation, some content data fields are filled automatically by the online journal club system, if known. In addition, in one implementation a content item can be generated automatically by the system (as will be described in more detail in sections to follow).

Once a content item is created by the user or the online journal club system, in one embodiment where for instance communication between the user's client computer and the journal club server is via the Internet, the content item is assigned a unique URL such that other users may access the content item via the URL. In one implementation, the user who created the content item can edit the content item after it is created. Certain content items (e.g., wikis) can also be edited by more than one user after the content item is created.

### 1.4.1 Associating Content Items

A content item can be associated with additional data. Non-limiting examples of this additional data include other content items, bibliographic entries, journal clubs, files, metadata, and user IDs. The associations can be stored in the system database. In one embodiment, a user has the ability to create associations when the content item is created. The user may also create associations after the content items have been created. In one implementation the user creates these associations using the aforementioned client computer interface.

As mentioned above, a user can have the ability to associate the content item with other content items. For instance, the user may associate a review of a research article with the bibliographic entry for that article. The user may also associate a comment with a post that another user has written. In one implementation, these associations between content items can be limited by the content type of the content item. In cases where the user has the ability to associate the content item with a journal club, the user can be required to be a member of the journal club. For example, in cases where the user has the ability to associate the content item with a file, a particular content item may be associated with many different files. Non-limiting examples of files include images, media, text files, and binary files. For instance, the user may associate a file by uploading the file from their client computer to the journal club system. In the case where the user has the ability to associate the content item with metadata (which is additional data associated with data), the metadata can include, without limitation, ratings, hyperlinks, folders, categories, keywords, tags, and text.

Further, in one implementation, certain associations between content items and additional data can be created automatically by the online journal club system. For instance, when a user creates a new content item, the new content item is automatically associated with the user's user ID. Additionally, the online journal club system can parse the list of authors from a bibliographic entry and associate the bibliographic entry with the user ID of the user whose name matches that of an author.

In one additional embodiment, the user and the online journal club system also have the ability to break associations.

### 1.4.2 Viewing Content Items

In general, users can view content items stored in the journal club system via their client computer. In implementations where communication between the user's client computer and the journal club server is via for instance the Internet, a user views a content item by accessing the content item's unique URL. When viewing the content item, in one version the user is shown the data fields that comprise the content item. The user can also view a list of the additional data associated with the content item. For instance, if the user is viewing the bibliographic entry for a research article, the interface may display the content items, files, metadata, and journal clubs associated with the bibliographic entry.

In one embodiment, users also have the ability to view a list of content items. In one implementation, the list of content items can be filtered based on criteria set by the user or by the online journal club system. Non-limiting examples of filtering criteria include content type, data fields of the content item, metadata values, number of files, and file type. The content items in the list can be displayed as content teasers. A content teaser includes a subset of the data fields that comprise the content item.

In one embodiment, the user is presented with a list of all the content items associated with a journal club when the user views the club. The user can then choose to view a list of a subset of the content items filtered by certain criteria. For instance, the user may choose to view a list of the event content items associated with the journal club. The user can further refine the list in order to view upcoming events associated with the journal club and tagged with a keyword (e.g., the keyword “neuroscience”).

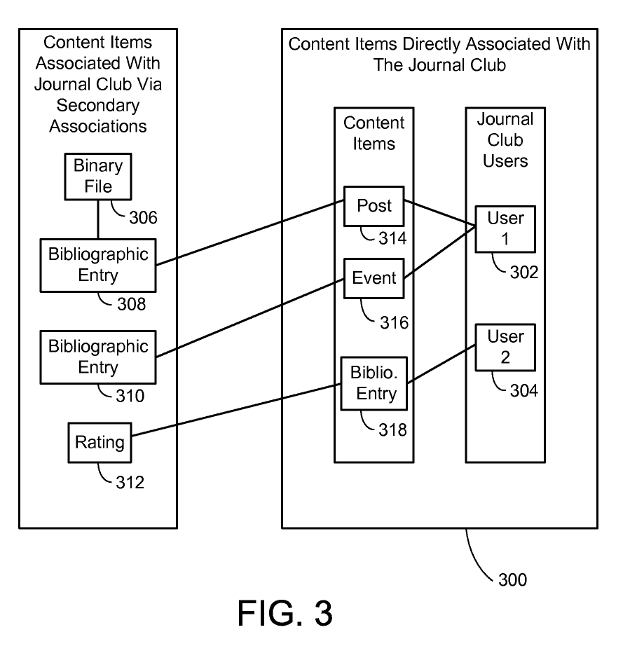

In one embodiment, more than one content item list can be displayed to the user at the same time. For example, this feature is useful when secondary associations exist. A secondary association is an association between two items, separated by an intermediate item. Thus, when viewing a journal club, the user can have the ability to view a list of the content items, metadata, and files associated with the journal club via secondary associations. For instance, as shown in FIG. 3, member users 302, 304 can view content items (i.e., binary file 306, bibliographic entries 308, 310, and rating 312) having secondary associations with content items (i.e., post 314, event 316 and bibliographic entry 318) directly associated with a journal club 300.

When a user views a list of content items associated with a journal club, in one embodiment one or more of the content types can be presented with its own unique user interface. For instance, when a user views events associated with the journal club, the user may view events sorted by date, in calendar form, and optionally can import and export events to other calendar applications (e.g., Google Calendar, iCalendar).

In order to more easily manage the content items associated with the journal club, in one embodiment moderators and member users can create folders associated with the journal club. The folder can be labeled, and then content items can be associated with the folder. The user can then choose to view only content items associated with a particular folder.

### 1.4.3 Bibliographic Entries

A bibliographic entry is a content type that the online journal club scheme gives a special set of properties. In general, a bibliographic entry provides bibliographic information about a scholarly work, such as an article published in a scholarly journal. Like other content items, the bibliographic entry includes at least one data field. Non-limiting examples of data fields for bibliographic entries include title, authors, publication, publisher, date of publication, bibliographic database identifier, URLs that link to the published work, URLs that link to related content and services, an issue number, and a volume number. Certain data fields can be required. For instance, the online journal club system can require that bibliographic entries have a recognized bibliographic database identifier. Non-limiting examples of the recognized bibliographic database identifiers include the Digital Object Identifier (DOI) and PubMed Unique Identifier (PMID). The online journal club system can be in communication with external bibliographic databases and identifier resolvers in order to access bibliographic information associated with an entry.

Each unique bibliographic entry stored in the system database also is assigned a separate system database identifier. In some cases, two or more bibliographic entries can be directed to the same scholarly work, but the data associated with the entries can vary somewhat. For example, the author's name or the title could be spelled differently in two bibliographic entries for the same work. In one implementation, these duplicate entries are assigned the same system database identifier. In view of this, when a new bibliographic entry is stored in the system database, it is determined whether it is a duplicate of an already stored entry before a system identifier is assigned. In one implementation, this determination involves computing a degree of similarity between the new entry and bibliographic entries previously stored in the database. This is followed by identifying previously stored bibliographic entries whose computed degree of similarity with the new entry is at a level deemed to be indicative of the new bibliographic entry being a variant of the previously stored entry. If a previously stored bibliographic entry is identified, its system identifier is assigned to the newly stored entry. Otherwise, a different and unique system identifier is assigned.

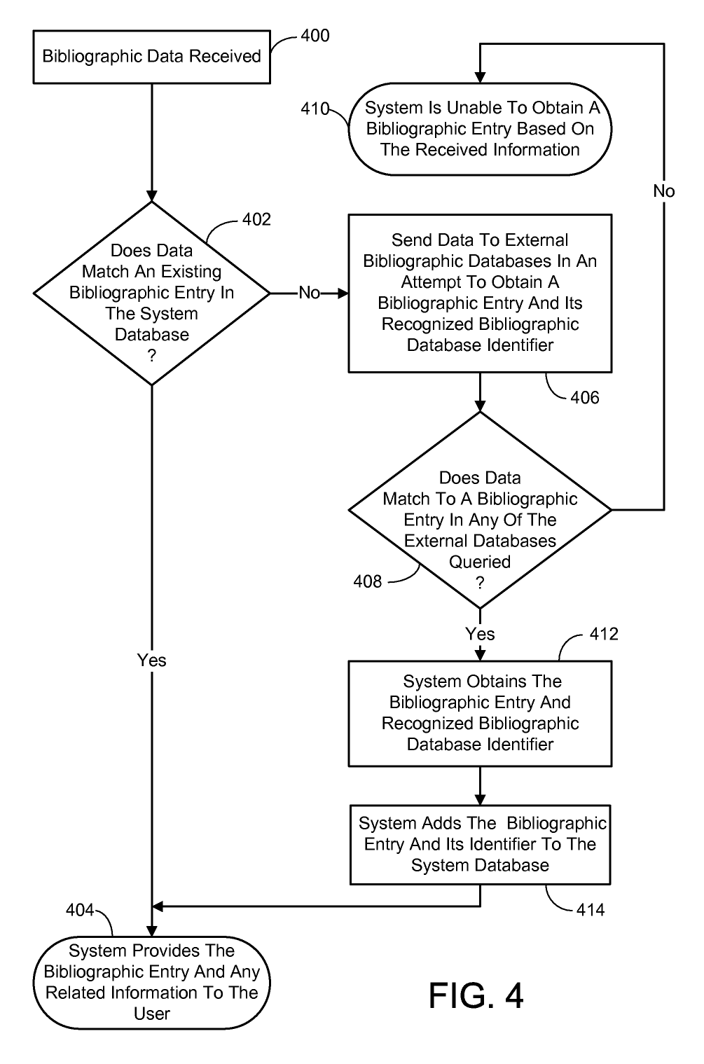

One way of providing bibliographic entries is by using a search system, as will be described in a subsequent section. FIGS. 4-7 illustrate various other exemplary implementations of how bibliographic entries are provided.

In the first exemplary implementation shown in FIG. 4, a user manually inputs bibliographic data to obtain a bibliographic entry. Referring to FIG. 4, the bibliographic data entered by the user is received by the online journal club system (400). It is then determined if the received information matches an entry already in the system database (402). If so, the system provides the bibliographic entry and any related information to the user (404), and the procedure ends. However, if there is no match, the received information is sent to one or more external bibliographic databases in an attempt to obtain a bibliographic entry and a recognized bibliographic database identifier for the entry, from one of the external databases (406). It is then determined the received information matches that of a bibliographic entry in any of the external databases queried (408). If not, then the system recognizes that it is unable to obtain a bibliographic entry based on the received information (410), and the procedure ends. If, however, the information matches, then the system obtains the corresponding bibliographic entry, as well as a recognized bibliographic database identifier for the entry (412). The obtained bibliographic entry and its identifier are added to the system database (414), and the system provides the bibliographic entry and any related information to the user (404). The procedure then ends.

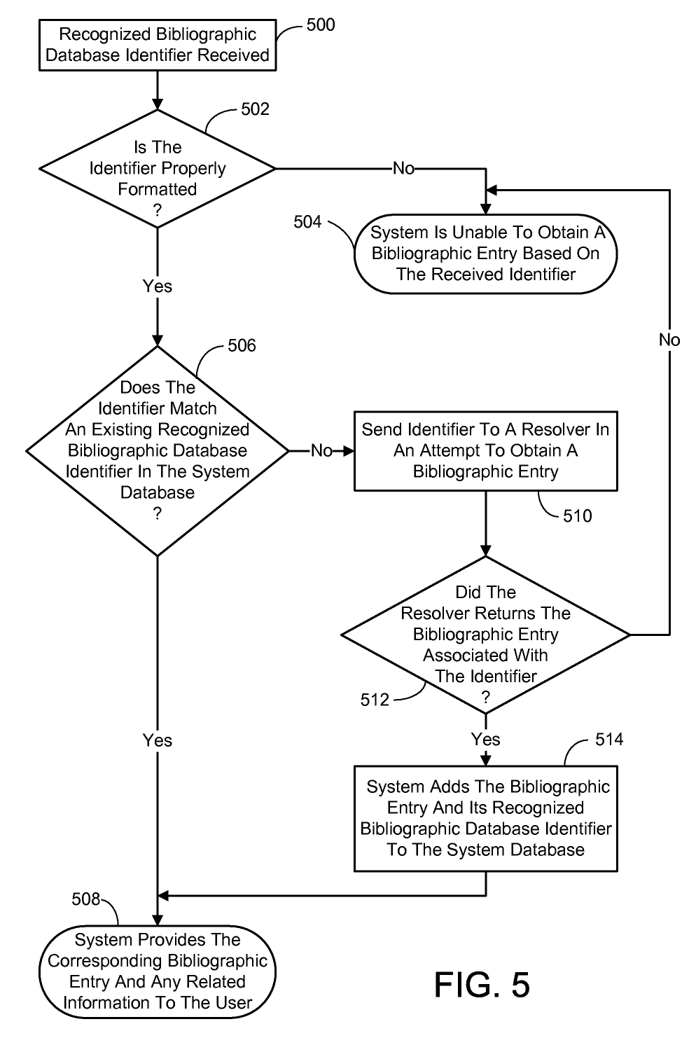

In another exemplary implementation shown in FIG. 5, a user inputs, or the online journal club system employs, a recognized bibliographic database identifier to provide a bibliographic entry. In general, the online journal club system automatically acquires the bibliographic data through an appropriate resolver. More particularly, referring to FIG. 5, a recognized bibliographic database identifier is received by the online journal club system (500). It is then determined if the received identifier is properly formatted (502). If not, then the system recognizes that it is unable to obtain a bibliographic entry based on the received identifier (504), and the procedure ends. If, however, the formatting is proper, it is next determined if the received recognized bibliographic database identifier matches an recognized bibliographic database identifier already in the system database (506). If so, the system provides the bibliographic entry and any related information (508), and the procedure ends. However, if there is no match, the received identifier is sent to an appropriate resolver in an attempt to obtain a bibliographic entry (510). It is then determined if the resolver returns the bibliographic entry associated with the identifier (512). If not, then the system recognizes that it is unable to obtain a bibliographic entry based on the received identifier (504), and the procedure ends. If, however, the bibliographic entry is returned by the resolver, then the bibliographic entry and its recognized bibliographic database identifier are added to the system database (514), and the system provides the bibliographic entry and any related information to the user (508). The procedure then ends.

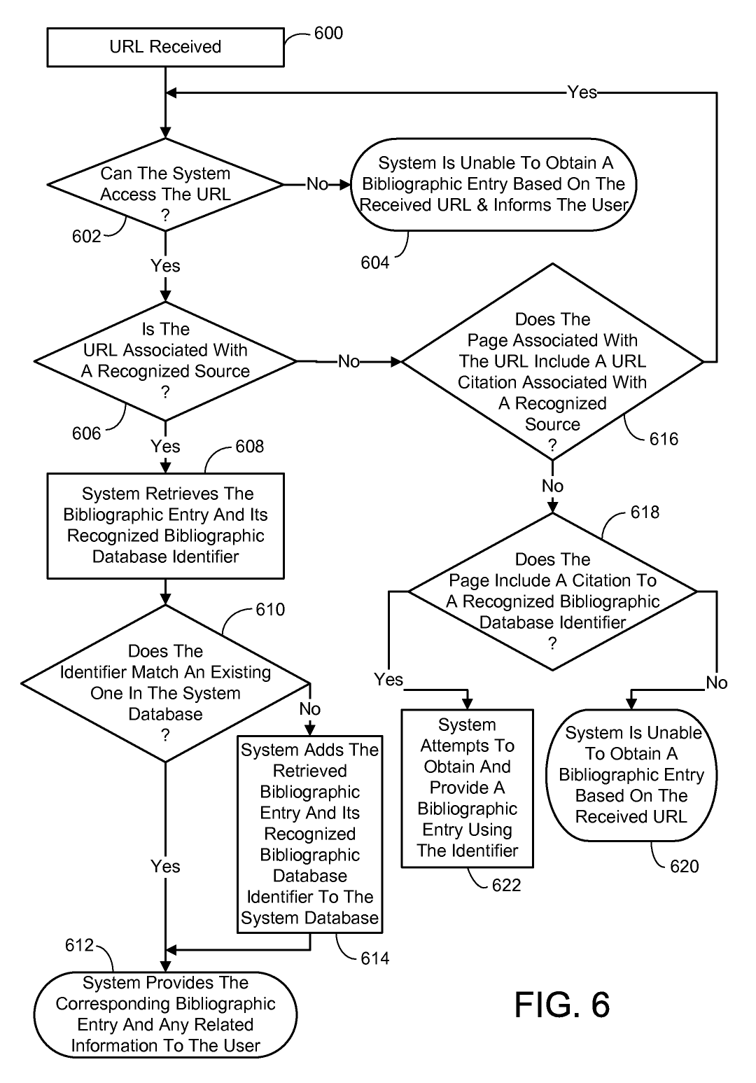

In another exemplary implementation shown in FIG. 6, a user inputs, or the online journal club system employs, a URL to provide a bibliographic entry. In general, the online journal club system automatically acquires the bibliographic data via a computer network such as the Internet. More particularly, referring to FIG. 6, a URL is received by the online journal club system (600). It is then determined if the system is able to access the URL (602). If not, then the system recognizes that it is unable to obtain a bibliographic entry based on the URL and informs the user of this fact if the URL was input by a user (604). The procedure then ends. If, however, the system is able to access the URL, it is next determined if the URL is associated with a recognized source (606). If so, the system retrieves the bibliographic entry corresponding to the URL and its recognized bibliographic database identifier (608). It is then determined if the retrieved identifier matches one already in the system database (610). If a match is found, then the system provides the bibliographic entry and any related information (612). If no match is found, the retrieved bibliographic entry and its recognized bibliographic database identifier are added to the system database (614), before the entry and any related information are provided (612). Either way the procedure ends. However, if at action (606) it is determined the URL is not associated with a recognized source, then it is determined if the page associated with the URL includes a citation to a URL that is associated with a recognized source, such as the website of a major publisher (616). If not, then it is determined if the aforementioned page includes a citation to a recognized bibliographic database identifier associated with a bibliographic entry (618). If it does not contain such a citation, then the system recognizes that it is unable to obtain a bibliographic entry based on the received URL (620), and the procedure ends. If, however, a citation to a recognized bibliographic database identifier is found, then the system attempts to obtain and provide a bibliographic entry using this identifier (622). In one version, action 622 is accomplished via the procedure of FIG. 5. On the other hand, if at action 616 it is determined the page associated with the received URL includes a citation to a URL that is associated with a recognized source, then actions 602 through 622 are repeated as appropriate.

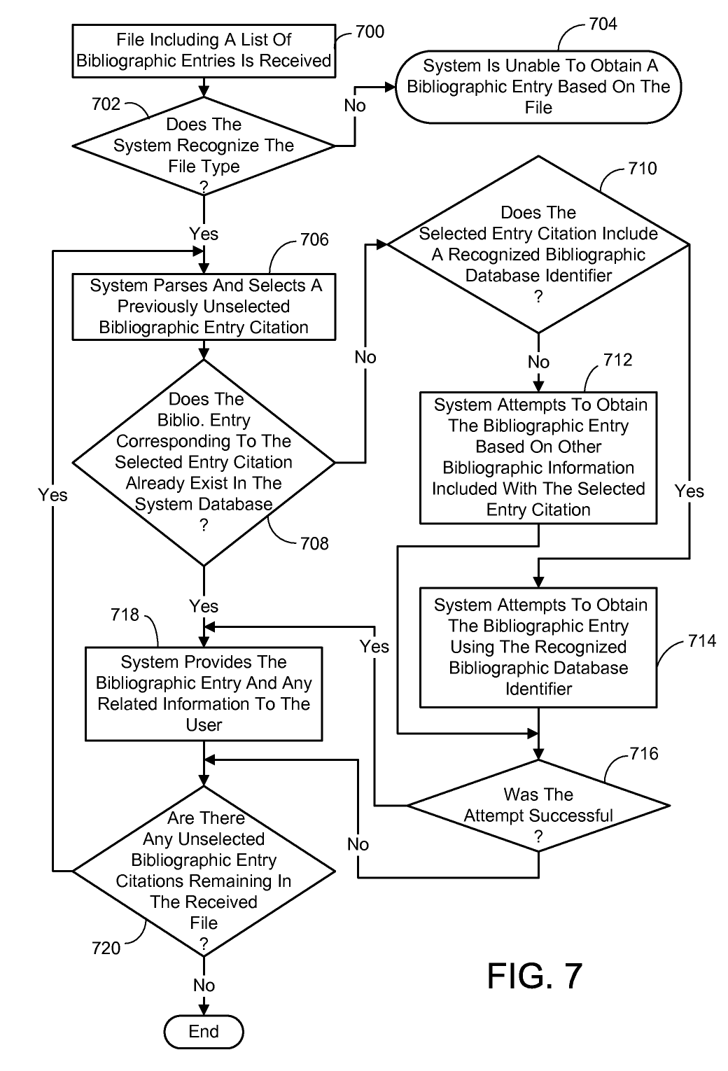

In another exemplary implementation shown in FIG. 7, a user inputs, or the online journal club system obtains, a file (such as but not limited to a BibTeX file) that includes a list of bibliographic entries. In general, the online journal club system automatically parses the file and acquires the bibliographic data. More particularly, referring to FIG. 7, the file including the list of bibliographic entries is received by the online journal club system (700). It is then determined if the file type is recognized by the system (702). If not, then the system recognizes that it is unable to obtain a bibliographic entry based on the file (704), and the procedure ends. If, however, the file type is recognized, a previously unselected bibliographic entry citation is parsed from the list and selected (706). It is then determined if the bibliographic entry corresponding to the selected entry citation already exists in the system database (708). If so, then the system provides the bibliographic entry and any related information (718). If not, then the system determines if the selected entry citation includes a recognized bibliographic database identifier (710). If it does not, then the system attempts to obtain the bibliographic entry based on other bibliographic information included with the selected entry citation (712). In one version, action 712 is accomplished using the procedure of FIG. 4. If, however, the selected entry citation includes a recognized bibliographic database identifier, the system attempts to obtain the bibliographic entry using this identifier (714). In one version, action 714 is accomplished using the procedure of FIG. 5. It is then determined if the foregoing attempts to obtain the bibliographic entry at actions 712 or 714 are successful (716). If successful, then the system provides the bibliographic entry and any related information (718). If the foregoing attempts are not successful, and whenever at action 718 the system provides the bibliographic entry, it is next determined if there are any unselected bibliographic entry citations remaining in the received file (720). If there are remaining unselected citations, then actions 706 through 720 are repeated as appropriate. When all the bibliographic entry citations in the received file have been selected and processed, the procedure ends.

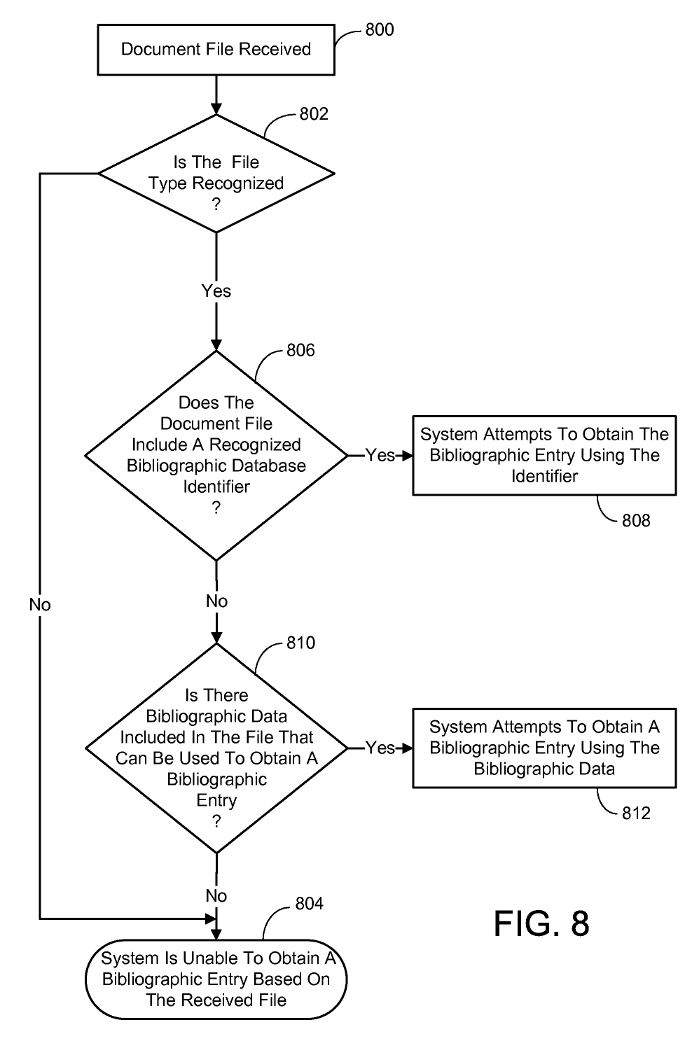

In another exemplary implementation shown in FIG. 8, a user inputs, or the online journal club system obtains, a document file (such as but not limited to a Portable Document Format file) that may include bibliographic data. In general, the online journal club system attempts to automatically identify this bibliographic data and use it to provide a bibliographic entry. More particularly, referring to FIG. 8, the document file is received by the online journal club system (800). It is then determined if the file type is recognized by the system (802). If not, then the system recognizes that it is unable to obtain a bibliographic entry based on the file (804), and the procedure ends. If, however, the file type is recognized, it is next determined if the document file includes a recognized bibliographic database identifier (806). If it does, the system attempts to obtain the bibliographic entry using this identifier (808). In one version, action 808 is accomplished using the procedure of FIG. 5. If, however, it is determined the document file does not include a recognized bibliographic database identifier, then the system determines if there is any other bibliographic information included that can be used to obtain a bibliographic entry (810). If such bibliographic information is found, the system attempts to obtain a bibliographic entry based on the discovered bibliographic information (812). In one version, action 812 is accomplished using the procedure of FIG. 4. If, on the other hand, it is determined that there is no bibliographic information included in the document file that can be used to obtain a bibliographic entry, then the system recognizes that it is unable to obtain a bibliographic entry based on the document file (804), and the procedure ends.

When the user creates a new content item, in one implementation he or she is provided with an interface to associate the content item with a bibliographic entry. If the bibliographic entry does not already exist in the database, the interface will enable the user to create a new bibliographic entry that can be associated with the content item being created.

When the user creates or views a bibliographic entry, in one implementation the online journal club system provides a link to the full document (e.g., a PDF) represented by the bibliographic entry. The online journal club system can attempt to automatically acquire the full document that the bibliographic entry refers to by accessing a URL linking to the full document. If the online journal club system can access the file, it will store the file in the system database, and associate the file with the bibliographic entry. If the online journal club system is unable to access the file due to copyright restrictions, the online journal club system can attempt to access the file by using client-side access to the URL linking to the full document. If the user has access to the file, the online journal club system can then access the file. The file is stored in the system database and associated with the bibliographic entry. The user can then download the full document from the original URL or from the online journal club system. In one version, the online journal club system also converts the full document into a content item of a particular content type.

In one implementation, it is possible for a user to create a list of bibliographic entries. This list can then be exported if the user desires.

### 1.4.4 Aggregating Additional Content Items

In one embodiment, the online journal club also aggregates feeds from scholarly websites, blogs and the like that are accessible via a computer network such as the Internet, but that are not a part of the system. To this end, the online journal club system identifies references to bibliographic entries, recognized bibliographic database identifiers and URLs within the feeds, and determines if they refer to a bibliographic entry of interest. If the bibliographic reference, recognized bibliographic database identifier or URL refers to a bibliographic entry of interest, the particular bibliographic entry and associated information from the referring website or blog is stored in the system database. A new content item is created by the system, which contains data from the referring website or blog. The content item is then associated with the bibliographic entry. It is noted that the feeds can include, but are not limited to, web feeds (e.g., RSS), crawled web pages, data accessed via an API, or any data stored in a database.

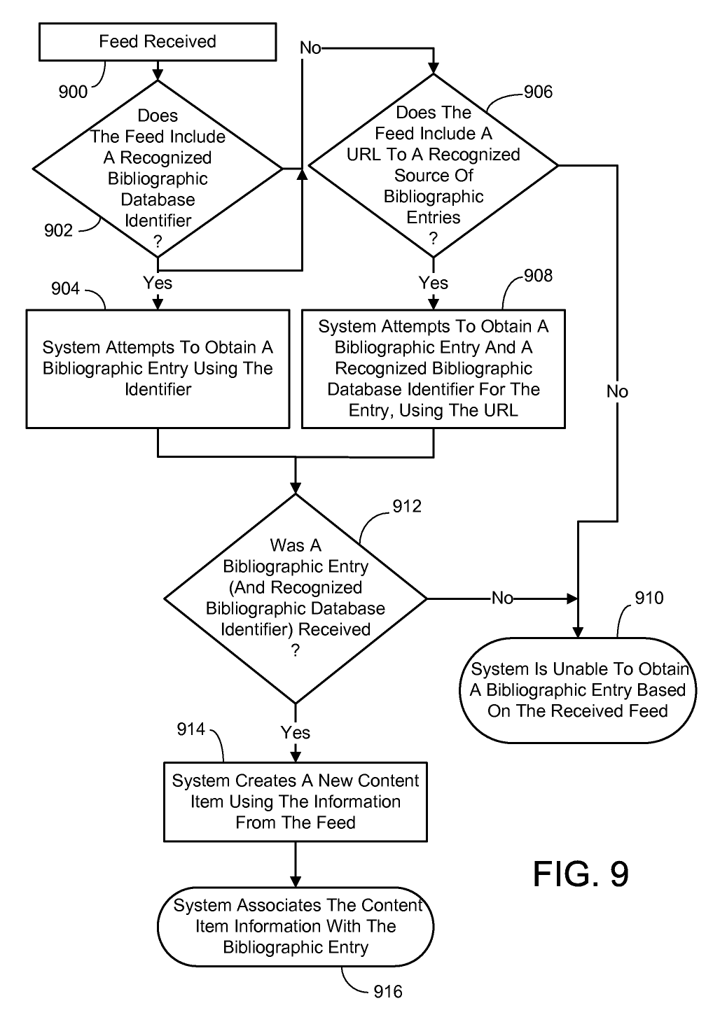

FIG. 9 illustrates an exemplary implementation of the aggregated feeds feature of the online journal club. Referring to FIG. 9, the implementation begins with the receipt of a feed from a scholarly website, blog, or the like by the online journal club system (900). It is then determined if the feed includes a recognized bibliographic database identifier (902). If so, the online journal club system attempts to obtain a bibliographic entry using the recognized bibliographic database identifier (904). In one version, this is accomplished as outlined in FIG. 5. If no recognized bibliographic database identifier is included in the received feed, or even if it is, the system next determines if the feed includes a URL to a recognized source of bibliographic entries (906). If it does, then the system attempts to obtain a bibliographic entry, and a recognized bibliographic database identifier for the entry, using the URL (908). In one version this is accomplished as outlined in FIG. 6. If the feed does not include URL from a recognized source, then the system recognizes that it is unable to obtain any further bibliographic entries based on the received feed (910), and the procedure ends. However, when an attempt to obtain a bibliographic entry is made, the system next determines if a bibliographic entry is actually received, and in the case where a URL was used to obtain the entry, if a recognized bibliographic database identifier is received as well (912). If so, the system creates a new content item using the information from the feed (914), and the content item information is associated with the bibliographic entry (916). If however, it is determined that no bibliographic entry is received, then the system recognizes that it is unable to obtain a bibliographic entry based on the received feed (910), and the procedure ends.

### 1.5 Subscriptions

In one embodiment of the online journal club scheme, a user can subscribe to feeds from journal clubs, content items, and other users. The user is notified that the item they have subscribed to has new content associated with it. The user is also notified when a subscribed to item has been edited. Non-limiting examples of these notifications may include email, RSS feeds, SMS messages, and notifications displayed by the client computer interface. For instance, if a user subscribes to feeds from a journal club, the user receives a notification when a new event has been associated with the journal club. If the user subscribes to feeds concerning a particular bibliographic entry, the user is notified when another user associates a comment with the particular bibliographic entry. In one implementation, the user chooses the type of notification they receive for a particular subscription. In addition, a user can alter their subscription from a particular content item, or from their user profile. In one implementation, some subscriptions may be created by default. Non-limiting examples of default subscriptions include subscriptions to the journal clubs the user is a member of, the content items the user has created, and content items the user has associated with their user ID. It is noted that the feeds may be formatted such that they may be read by RSS readers and aggregators.

### 1.6 User Profiles

In one embodiment when a user creates an account as described previously, a user profile is established. The user profile is an interface that can be assigned a unique URL (such as in Internet embodiments). The user profile enables users to provide information about themselves, manage content they have associated with their user ID, manage their subscriptions, and manage other options related to the online journal club system. In one implementation, the user profile displays the journal clubs, content items, metadata, files, and users that are associated with the user's user ID. The user profile can also display the user's subscriptions to journal clubs, content items, and other users. In addition, in one implementation users can choose what information of their profile is made publicly available, and what information is to remain private. The user can also choose which users may view the private information. Still further, in one implementation a user can create folders associated with his or her user profile. The user can label the folders and add content from the online journal club system to their folders. Certain folders can also exist as default folders. Non-limiting examples of default folders include Favorites, To Read, and My Publications. Users can be provided with features that easily enable them to populate their My Publications folder with bibliographic entries. For example, the online journal club system can be configured to search the system database and other bibliographic databases for bibliographic entries in which the author field matches the name of the user. The discovered entries would then be added to the user-author's My Publications folder. Alternately, the user can select the particular discovered bibliographic entries that they would like added to their My Publications folder. User can also refine the search results using keywords prior to all or selected entries being added.

### 1.7 Rating Scheme

In one embodiment, a rating scheme is included. The rating scheme enables users to associate ratings with journal clubs, content items, and users. Journal clubs, content items, and users may then be viewed and sorted according to the associated ratings. For example, an average rating can be used. In one implementation, the rating scheme also applies ratings directly to content items, or to journal clubs, and users associated with rated content items. For instance, if the user creates a post, and another user rates the post highly, then the author of the post can be given a high rating. Similarly, journal clubs may be rated based on the ratings of the content items associated with the club. In one implementation, the rating scheme also provides the ability to view and sort data fields of content items according to rating. For instance, a user may view the list of journal publications sorted by highest average rating based on the ratings of bibliographic entries.

It is noted that when ratings are averaged, the ratings given by certain users may be weighted higher or lower than other users. For instance, if a user has received high ratings in the past, the next rating the user gives would be weighted higher than normal. The weight given to a user's rating can be determined by many factors. Non-limiting examples of these factors include the ratings the user has received, the number of publications the user has, the number of content items the user has created, and the number of users that subscribe to the user.

It is also noted that the types of ratings, and the rating scale, can be defined by the rating scheme or by the users. The type of rating can differ based on content type. For instance, bibliographic entries might be rated on a 1 to 5 scale, whereas comments would be rated on a −1 to 1 scale. Additionally, content items can receive more than one type of rating. For instance, the user could separately rate a bibliographic entry on significance, reliability, and presentation.

Ratings can also be used as for moderation purposes. For example, in one implementation content that receives low ratings is automatically hidden from users. In addition, users that repeatedly post content which receives low ratings could be banned from the system.

### 1.8 Recommendations

In one embodiment, a recommendation scheme is included. The recommendation scheme may implement at least one type of recommendation technique. Non-limiting examples of types of recommendation techniques include content-based, collaborative, and hybrid recommendation techniques. Non-limiting examples of information that may be used to generate recommendations include information from a user's profile; content items, journal clubs, metadata, files, and users associated with a user; the user's page views; and the current page a user is viewing. A user receives recommendations of content items, journal clubs, metadata, files, and users. Non-limiting examples of ways the user can receive recommendations include email, RSS feeds, SMS messages, and notifications displayed by the client computer interface.

In one implementation, a user can to associate a rating with the recommendation the user receives. If the user rates a recommendation, the system will apply that information to the recommendation technique. Recommendations can also spread from user to user. If a particular user rates a recommendation highly, then the online journal club system would send the recommendation to users that have subscribed to that particular user. The online journal club system can also send the recommendation to users that are associated with the particular user (e.g., users that are members of the same journal club).

In one implementation, the system uses recommendation information to provide the user with advertisements targeted to the user's interests.

### 1.9 Search System

In one embodiment, a search scheme is included. The search scheme provides a user with an interface to search the journal clubs, content items, metadata, files, and users that are stored by the online journal club system. Users can filter search results based on filtering criteria. Non-limiting examples of filtering criteria include keywords, content type, content data field values, metadata values, number of files, and file type. In one implementation, the system also provides an interface to enable a user to search external databases (e.g., PubMed, arxiv).

### 2.0 The Computing Environment

A brief, general description of a suitable computing environment in which portions of the embodiments for managing and conducting on-line scholarly journal clubs described herein may be implemented will now be described. These embodiments are operational with numerous general purpose or special purpose computing system environments or configurations. Exemplary well known computing systems, environments, and/or configurations that can be suitable include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the aforementioned systems or devices, and the like.

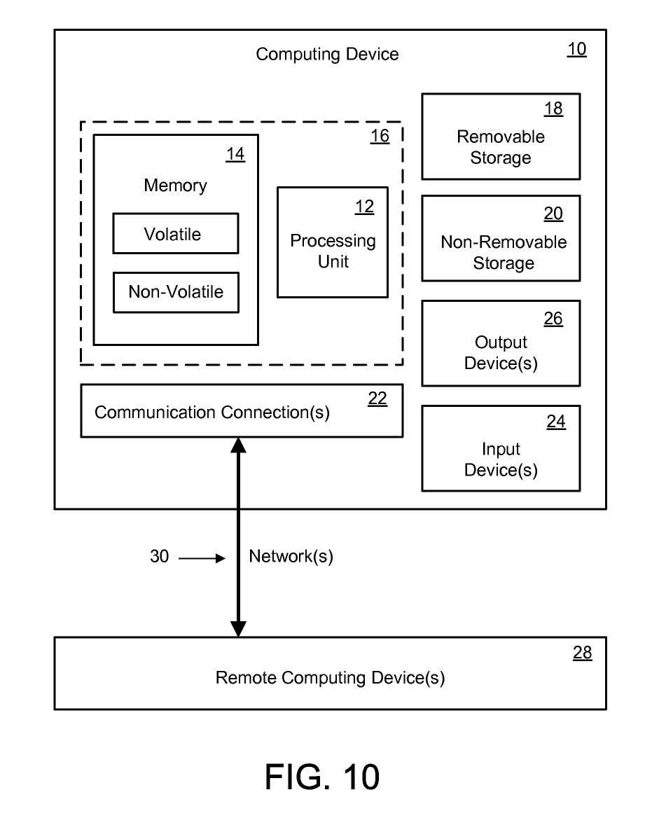

FIG. 10 illustrates an exemplary embodiment, in simplified form, of a suitable computing system environment. The environment illustrated in FIG. 10 is only one example of a suitable computing system environment and is not intended to suggest any limitation as to the scope of use or functionality of the embodiments for managing and conducting on-line scholarly journal clubs described herein. Neither should the computing system environment be interpreted as having any dependency or requirement relating to any one or combination of components exemplified in FIG. 10.

As exemplified in FIG. 10, a system for implementing portions of the embodiments for managing and conducting on-line scholarly journal clubs described herein includes one or more computing devices, such as computing device 10. In its simplest configuration, computing device 10 typically includes at least one processing unit 12 and memory 14. Depending on the specific configuration and type of computing device, the memory 14 can be volatile (such as RAM), non-volatile (such as ROM and flash memory, among others) or some combination of the two. This simplest configuration is illustrated by dashed line 16.

As exemplified in FIG. 10, computing device 10 can also have additional features and functionality. By way of example, computing device 10 can include additional storage such as removable storage 18 and/or non-removable storage 20. This additional storage includes, but is not limited to, magnetic disks, optical disks and tape. Computer storage media typically embodies volatile and non-volatile media, as well as removable and non-removable media implemented in any method or technology. The computer storage media provides for storage of various information needed to operate the device 10 such as computer readable instructions associated with an operating system, application programs and other program modules, and data structures, among other things. Memory 14, removable storage 18 and non-removable storage 20 are all examples of computer storage media. Computer storage media includes, but is not limited to, RAM, ROM, EEPROM, flash memory or other memory technology, CD-ROM, digital versatile disks (DVD) or other optical disk storage technology, magnetic cassettes, magnetic tape, magnetic disk storage or other magnetic storage devices, or any other physical medium which can be used to store the desired information and which can be accessed by computing device 10. Any such computer storage media can be part of computing device 10. The term “computer-readable storage medium” as used herein refers to the aforementioned storage media.

As exemplified in FIG. 10, computing device 10 also includes a communications connection(s) 22 that allows the device to operate in a networked environment and communicate with a remote computing device(s), such as remote computing device(s) 28. Remote computing device(s) 28 can be a PC, a server, a router, a peer device, or other common network node, and typically includes many or all of the elements described herein relative to computing device 10. Communication between computing devices takes place over a network(s) 30, which provides a logical connection(s) between the computing devices. The logical connection(s) can include one or more different types of networks including, but not limited to, a local area network(s) (LAN) and wide area network(s) (WAN). Such networking environments are commonplace in conventional offices, enterprise-wide computer networks, intranets and the Internet. It will be appreciated that the communications connection(s) 22 and related network(s) 30 described herein are exemplary and other means of establishing communication between the computing devices can be used.

As exemplified in FIG. 10, computing device 10 also includes an input device(s) 24 and output device(s) 26. Exemplary input devices 24 include, but are not limited to, a keyboard, a GUI selection device such as a mouse and the like, a pen, a touch input device, a microphone, and a camera, among others. A user can enter commands and various types of information into the computing device 10 through the input device(s) 24. Exemplary output devices 26 include, but are not limited to, a display device(s), a printer, and audio output devices, among others. The user can select items in a GUI displayed on a display device via the GUI selection device. These input and output devices are well known and need not be described at length here.

Referring again to FIG. 10, the embodiments for managing and conducting on-line scholarly journal clubs described herein can be further described in the general context of computer-executable instructions, such as program modules, which are executed by computing device 10. Generally, program modules include routines, programs, objects, components, and data structures, among other things, that perform particular tasks or implement particular abstract data types. The embodiments described herein can also be practiced in a distributed computing environment where tasks are performed by one or more remote computing devices 28 that are linked through a communications network 22/30. In a distributed computing environment, program modules can be located in both local and remote computer storage media including, but not limited to, memory 14 and storage devices 18/20.

### 3.0 Other Embodiments

The foregoing description of embodiments for managing and conducting online scholarly journal clubs can also be employed for other groups that discuss and evaluate scholarly research articles and other content. Non-limiting examples of these groups include laboratory groups, conferences, and academic courses.

It is noted that any or all of the aforementioned embodiments, implementations and versions throughout the description may be used in any combination desired to form additional hybrid embodiments, implementations and versions. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. A computer-implemented process for managing and conducting scholarly journal clubs over a client-server based computer network, comprising using a journal club server computer and a database associated with the server to perform the following process actions:
receiving bibliographic entries from users over the client-server based computer network, wherein a bibliographic entry is a representation of a scholarly work;
storing the bibliographic entries in the database;
assigning an identifier to each new bibliographic entry stored in the database, wherein the same identifier is assigned to each bibliographic entry corresponding to the same scholarly work;
receiving and implementing an association request from a user to associate at least one of another user, or a group of users, or a content item with a stored bibliographic entry using the entry's identifier; and
allowing a user, or a group of users, access to a stored bibliographic entry and any content item associated therewith.

2. The process of claim 1, wherein a bibliographic entry comprises at least one data field, wherein each data field comprises a designation of one of a title, or an author, or a publication, or a publisher, or a date of publication, or a bibliographic database identifier, or a URL that links to a published work, or a URL that links to related content, or a URL that links to related services, or an issue number, or a volume number.

3. The process of claim 1, wherein a content item comprises one of a comment, or an event, or a Universal Resource Locator (URL), or an image, or a video, or an article, or a post, or a recommendation, or a wiki, or a binary file, or a keyword, or a tag, or meta-data, or a hyperlink, or another bibliographic entry, or a variant of the same bibliographic entry to which the content item is associated.

4. The process of claim 1, wherein the process action of assigning an identifier to each new bibliographic entry stored in the database, comprises the actions of:
for each new bibliographic entry stored in the database,
computing a degree of similarity between the new entry and bibliographic entries previously stored in the database,
identifying each previously stored bibliographic entry whose computed degree of similarity with the new entry is at a level previously designated as being indicative of the new bibliographic entry being a variant of the previously stored entry,
assigning the same identifier to the new bibliographic entry as was assigned to a previously stored entry whose computed degree of similarity with the new entry is at a level previously designated as being indicative of the new bibliographic entry being a variant of the previously stored entry, and
assigning a different and unique identifier to the new bibliographic entry whenever no previously stored entry is identified as having a computed degree of similarity with the new entry that is at a level previously designated as being indicative of the new bibliographic entry being a variant of the previously stored entry.

5. The process of claim 1, wherein the process action of allowing a user, or a group of users, access to a stored bibliographic entry and any content item associated therewith, comprises an action of allowing the user or group access to a stored bibliographic entries and content items associated therewith in response to the user or group submitting the identifier assigned to the entry.

6. The process of claim 1, wherein a bibliographic entry is a representation of a scholarly work, and wherein the content item is an event, and wherein the process action of receiving and implementing an association request from a user to associate at least one of another user, or a group of users, or a content item with a stored bibliographic entry using the entry's identifier, comprises an action of receiving and implementing an association request from a user to associate an invitation to other users to participate in a discussion of a scholarly work represented by the stored bibliographic entry.

7. The process of claim 1, wherein the process action of allowing a user, or a group of users, access to a stored bibliographic entry and any content item associated therewith, comprises the actions of:
receiving bibliographic information;
determining if the received bibliographic information corresponds to an bibliographic entry resident in the database;
whenever it is determined the received bibliographic information corresponds to a bibliographic entry resident in the database, providing the bibliographic entry and any related information to a user.

8. The process of claim 7, further comprising the process action of:
whenever it is determined the received bibliographic information does not correspond to a bibliographic entry resident in the database, sending the received information to one or more external bibliographic databases in an attempt to obtain a bibliographic entry and a recognized bibliographic database identifier for the entry; and
whenever it is determined that the received information corresponds to a bibliographic entry resident in an external bibliographic database,
obtaining the corresponding bibliographic entry, as well as a recognized bibliographic database identifier for the entry,
storing the obtained bibliographic entry and its recognized bibliographic database identifier in the journal club server database, and
providing the obtained bibliographic entry and any related information to a user.

9. The process of claim 1, wherein the process action of allowing a user, or a group of users, access to a stored bibliographic entry and any content item associated therewith, comprises the actions of:
receiving a recognized bibliographic database identifier;
determining if the received recognized bibliographic database identifier corresponds to a recognized bibliographic database identifier already in the journal club server database; and
whenever it is determined the received recognized bibliographic database identifier corresponds to a recognized bibliographic database identifier resident in the journal club server database, providing a bibliographic entry associated with the recognized bibliographic database identifier and any related information to a user.

10. The process of claim 9, further comprising the process action of:
whenever it is determined the received recognized bibliographic database identifier does not correspond to a recognized bibliographic database identifier resident in the journal club server database, sending the received recognized bibliographic database identifier to a resolver in an attempt to obtain a bibliographic entry; and
whenever the resolver returns a bibliographic entry,
storing the returned bibliographic entry and its recognized bibliographic database identifier in the database, and
providing the returned bibliographic entry and any related information to a user.

11. The process of claim 1, wherein the process action of allowing a user, or a group of users, access to a stored bibliographic entry and any content item associated therewith, comprises the actions of:
receiving a Universal Resource Locator (URL) corresponding to a bibliographic entry;
retrieving the bibliographic entry corresponding to the received URL and its recognized bibliographic database identifier via a computer network;
determining if the retrieved recognized bibliographic database identifier corresponds to a recognized bibliographic database identifier already in the journal club server database;
whenever it is determined the received recognized bibliographic database identifier corresponds to a recognized bibliographic database identifier resident in the journal club server database, providing a bibliographic entry associated with the recognized bibliographic database identifier and any related information to a user; and
whenever it is determined the received recognized bibliographic database identifier does not corresponds to a recognized bibliographic database identifier resident in the journal club server database,
storing the retrieved bibliographic entry and its recognized bibliographic database identifier in the journal club server database, and
providing the retrieved bibliographic entry and any related information to a user.

12. The process of claim 1, wherein the process action of allowing a user, or a group of users, access to a stored bibliographic entry and any content item associated therewith, comprises the actions of:
(a) receiving a file which comprises a list of bibliographic entry citations;
(b) parsing and selecting a previously unselected bibliographic entry citation;
(c) determining if a bibliographic entry corresponding to the selected entry citation is stored in the database;
(d) whenever the bibliographic entry corresponding to the selected entry citation is determined to be stored in the database, providing the bibliographic entry and any related information to a user;
(e) whenever the bibliographic entry corresponding to the selected entry citation is determined not to be stored in the database, attempting to obtain the bibliographic entry based on bibliographic information or a recognized bibliographic database identifier included with the selected entry citation;
(f) whenever the bibliographic entry corresponding to the selected entry citation is obtained using bibliographic information or a recognized bibliographic database identifier included with the selected entry citation, providing the retrieved bibliographic entry and any related information to the user;
(g) determining if there are any unselected bibliographic entry citations remaining in the received file;
(h) whenever it is determined that there are unselected bibliographic entry citations remaining in the received file, repeating actions (b) through (h).

13. The process of claim 1, wherein the process action of allowing a user, or a group of users, access to a stored bibliographic entry and any content item associated therewith, comprises the actions of:
receiving a document file which comprises bibliographic information or a recognized bibliographic database identifier;
identifying the bibliographic information or recognized bibliographic database identifier in the document file;
determining if the identified bibliographic information or recognized bibliographic database identifier is stored in the journal club server database;
whenever the bibliographic information or recognized bibliographic database identifier is determined to be stored in the journal club server database, providing the a bibliographic entry and any related information corresponding the bibliographic information or recognized bibliographic database identifier to a user;
whenever the bibliographic information or recognized bibliographic database identifier is determined not to be stored in the journal club server database, attempting to obtain the bibliographic entry based on the bibliographic information or recognized bibliographic database identifier included in the document file;
whenever the bibliographic entry corresponding the bibliographic information or recognized bibliographic database identifier included in the document file is obtained, providing the obtained bibliographic entry and any related information to the user.

14. The process of claim 1, further comprising the process actions of:
searching for and obtaining bibliographic entries via a computer network from external sources;
storing the obtained bibliographic entries, and any associated bibliographic information in the database.

15. The process of claim 14, wherein the process action of searching for and obtaining bibliographic entries via a computer network from external sources, comprises the actions of:
receiving a data feed from an external source;
determining if the feed includes a recognized bibliographic database identifier;
whenever the feed includes a recognized bibliographic database identifier, attempting to obtain a bibliographic entry corresponding to the recognized bibliographic database identifier;
determining if the feed includes a URL to a recognized source of bibliographic entries; and
whenever the feed includes a URL to a recognized source of bibliographic entries, attempting to obtain a bibliographic entry and associated recognized bibliographic database identifier using the URL.

16. The process of claim 1, further comprising the process actions of:
receiving a subscription request from a user to notify the user whenever a new user, or bibliographic entry, or content item has been associated with a user, or bibliographic entry, or content item identified in the subscription request;
notifying the user who sent the subscription request of any new user, or bibliographic entry, or content item that have been associated with the user, or bibliographic entry, or content item identified in the subscription request;
receiving a subscription request from a user to notify the user whenever a specified user, or bibliographic entry, or content item has been edited; and
notifying the user who sent the subscription request of any edits to the specified user, or bibliographic entry, or content item.

17. The process of claim 1, further comprising the process actions of:
receiving a rating request from a user to associate a rating with a content item, or user, or group of users, or bibliographic entry;
associating the rating received in the user's request with the specified content item, or user, or group of users, or bibliographic entry;
generating ratings for a content item, or user, or group of users, or bibliographic entry;
associating the generated rating with the rated content item, or user, or group of users, or bibliographic entry; and
whenever presenting a list of content items, or users, or groups of users, or bibliographic entries, sorting the list according to any associated ratings.

18. The process of claim 1, further comprising process actions of:
identifying content items, or users, or groups of users, or bibliographic entries that are deemed to be of interest to a user or group of users; and
providing a recommendation of the identified content items, or users, or groups of users, or bibliographic entry, to the user or group of users deemed to be interested therein.

19. The process of claim 1, further comprising process actions of:
receiving a request from a user to create a group of users;
creating the requested group of users;
receiving a request from a user to associate at least one of an additional user, or a bibliographic entry, or a content item with the group of users; and
associating each additional user, or bibliographic entry, or content item requested with the group of users.

20. The process of claim 1, further comprising process actions of:
receiving a request from a user to input a content item submitted by the user;
inputting and storing the user-submitted content item; and
generating and storing additional content items not submitted by a user.
